(19) United States
(12) Patent Application Publication
(10) Pub. No.: US 2024/0129669 A1
(43) Pub. Date: Apr. 18, 2024

(54) DISTRIBUTION SYSTEM, SOUND OUTPUTTING METHOD, AND NON-TRANSITORY COMPUTER-READABLE RECORDING MEDIUM

(71) Applicant: YAMAHA CORPORATION, Hamamatsu-shi (JP)

(72) Inventors: Masaru TANAKA, Hamamatsu-shi (JP); Yoshifumi MIZUNO, Hamamatsu-shi (JP); Takashi MORI, Hamamatsu-shi (JP); Akira MAEZAWA, Hamamatsu-shi (JP); Ryunosuke DAIDO, Hamamatsu-shi (JP); Kazunobu KONDO, Hamamatsu-shi (JP)

(21) Appl. No.: 18/395,901

(22) Filed: Dec. 26, 2023

Related U.S. Application Data
(63) Continuation of application No. PCT/JP21/24634, filed on Jun. 29, 2021.

(51) Int. Cl. H04R 3/12; H04R 5/04

(52) U.S. Cl. CPC H04R 3/12; H04R 5/04

(57) ABSTRACT

A distribution system includes a device control circuit that receives a first sound signal and a second sound signal that are related to a performance sound to be distributed. The device control circuit also receives meta-data indicating a type of the first sound signal and a type of the second sound signal. The device control circuit also receives sound environment data indicating a sound characteristic of a sound appliance. Based on a combination of the type of the first sound signal and the sound characteristic or a combination of the type of the second sound signal and the sound characteristic, the device control circuit controls the first sound signal or the second sound signal to be output to the sound appliance.

### CROSS-REFERENCE TO RELATED APPLICATIONS

The present application is a continuation application of International Application No. PCT/JP2021/024634, filed Jun. 29, 2021. The contents of this application are incorporated herein by reference in their entirety.

### BACKGROUND

### Field

The present disclosure relates to a distribution system, a sound outputting method, and a non-transitory computer-readable recording medium.

### Background Art

JP 2008-131379A discloses a system that distributes, live, a moving image of singing performance and/or musical performance. In this system, the singer(s) and musical performer(s) perform at different places. At each of the places, a camera is set. A control center synthesizes moving images obtained from the cameras to generate a distribution moving image, and distributes the distribution moving image to receiving terminals.

There are a wide range of sound appliances provided in distribution viewing places. Examples of such sound appliances include professional audio equipment and smartphones. The sound output from professional audio equipment exhibits distinct characteristics compared with the sound output from smartphones. Under the circumstances, there is a need for a technique that makes a sound adapted to a sound appliance provided in each of a plurality of distribution destinations.

The present disclosure has been made in view of the above-described and other circumstances, and has an object to output a sound adapted to an audio appliance provided in a distribution viewing place.

### SUMMARY

One aspect is a distribution system that includes a device control circuit configured to receive a first sound signal and a second sound signal that are related to a performance sound to be distributed. The device control circuit is also configured to receive meta-data indicating a type of the first sound signal and a type of the second sound signal. The device control circuit is also configured to receive sound environment data indicating a sound characteristic of a sound appliance. The device control circuit is also configured to, based on a combination of the type of the first sound signal and the sound characteristic or a combination of the type of the second sound signal and the sound characteristic, control the first sound signal or the second sound signal to be output to the sound appliance.

Another aspect is a sound outputting method performed by a computer used in a distribution system. The method includes receiving a first sound signal and a second sound signal that are related to a performance sound to be distributed. The method also includes receiving meta-data indicating a type of the first sound signal and a type of the second sound signal. The method also includes receiving sound environment data indicating a sound characteristic of a sound appliance. The method also includes, based on a combination of the type of the first sound signal and the sound characteristic or a combination of the type of the second sound signal and the sound characteristic, controlling the first sound signal or the second sound signal to be output to the sound appliance.

Another aspect is a non-transitory computer-readable recording medium storing a program that, when executed by at least one computer used in a distribution system, cause the at least one computer to perform a method including receiving a first sound signal and a second sound signal that are related to a performance sound to be distributed. The method also includes receiving meta-data indicating a type of the first sound signal and a type of the second sound signal. The method also includes receiving sound environment data indicating a sound characteristic of a sound appliance. The method also includes, based on a combination of the type of the first sound signal and the sound characteristic or a combination of the type of the second sound signal and the sound characteristic, controlling the first sound signal or the second sound signal to be output to the sound appliance.

The above-described aspects ensure that a sound adapted to an audio appliance provided in a distribution viewing place is output.

### BRIEF DESCRIPTION OF THE DRAWINGS

A more complete appreciation of the present disclosure and many of the attendant advantages thereof will be readily obtained as the same becomes better understood by reference to the following detailed description when considered in connection with the following figures.

FIG. 1 is a schematic illustration of a distribution system 1 according to one embodiment.

FIG. 2 is a block diagram illustrating an example configuration of the distribution system 1 according to the one embodiment.

FIG. 3 illustrates an example of sound environment data 120 according to the one embodiment.

FIG. 4 illustrates an example of registration data 121 according to the one embodiment.

FIG. 5 illustrates an example of meta-data 220 according to the one embodiment.

FIG. 6 is a sequence chart of processing performed by the distribution system 1 according to the one embodiment.

FIG. 7 is a flowchart of processing performed by a viewer terminal 10 according to the one embodiment.

### DESCRIPTION OF THE EMBODIMENTS

The present development is applicable to a distribution system, a sound outputting method, and a non-transitory computer-readable recording medium.

The distribution system 1 according to the one embodiment will be described by referring to the accompanying drawings.

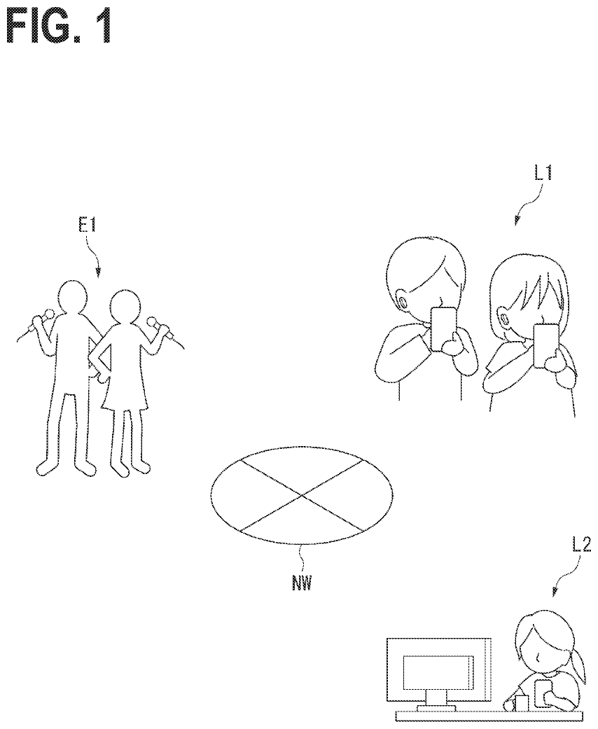

FIG. 1 is a schematic representation of the distribution system 1 according to the one embodiment. The distribution system 1 is a system that distributes, in real-time, a live performance to a plurality of viewers while the live performance is being carried out by performers. As illustrated in FIG. 1, in the distribution system 1, a moving image and/or a sound related to a musical performance (hereinafter referred to as “performance”) carried out by a performer(s) E1 is distributed to viewers L (viewers L1 and L2) through a communication network NW. The viewers L1 and L2 receive and view the performance using, for example, a smartphone, a portable terminal, a tablet, or a PC (Personal Computer).

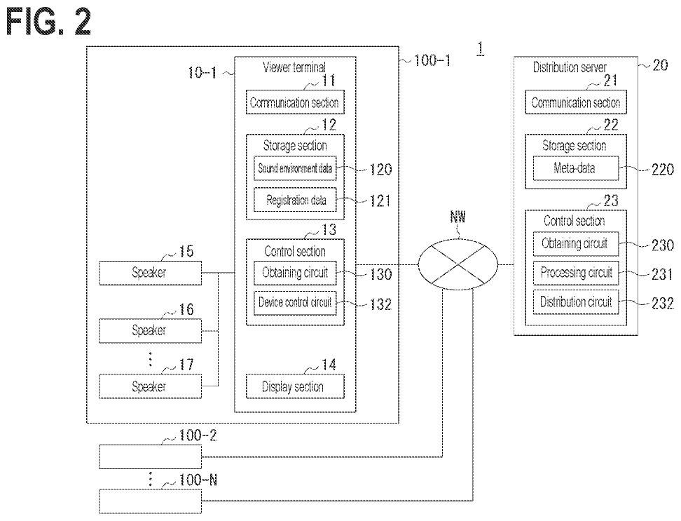

FIG. 2 is a block diagram illustrating an example configuration of the distribution system 1 according to the one embodiment. The distribution system 1 includes a plurality of viewer systems 100 (viewer systems 100-1 to 100-N; N is a natural number), the communication network NW, and a distribution server 20.

The distribution server 20 distributes various signals indicating a moving image and/or a sound related to a performance. The distribution server 20 is a computer such as a server device, a cloud server, and a PC.

The viewer system 100 is a system in which the viewer terminal 10 is connected to a plurality of speakers (speakers 15 to 17). The viewer terminal 10 receives information distributed from the distribution server 20. the viewer terminal 10 is a computer such as a smartphone, a PC, and a tablet terminal. The viewer system 100 is used by each one of the viewers. For example, the viewer system 100-1 is used by one viewer, and the viewer system 100-2 is used by another viewer. The speaker provided in the viewer system 100 varies from viewer system 100 to viewer system 100. That is, each one viewer system 100 has a unique sound characteristic.

The communication network NW connects the plurality of viewer systems 100 and the distribution server 20 in a manner in which each viewer system 100 is communicable with the distribution server 20. An example of the communication network NW is a wide-area network, such as a WAN (Wide Area Network), the Internet, and a combination of a WAN and the Internet.

Next, a configuration of the distribution server 20 will be described. The distribution server 20 includes a communication section 21, a storage section 22, and a control section 23. The communication section 21 communicates with each viewer terminal 10 through the communication network NW.

The storage section 22 is implemented by a storage medium such as an HDD (Hard Disk Drive), a flash memory, an EEPROM (Electrically Erasable Programmable Read Only Memory), a RAM (Random Access read/write Memory), a ROM (Read Only Memory), or a combination of the foregoing. The storage section 22 stores a program for performing various kinds of processing in the distribution server 20, and stores temporary data used in the various kinds of processing. The storage section 22 stores, for example, the meta-data 220. The meta-data will be described in detail later.

The control section 23 is implemented by executing a program in CPU (Central Processing Unit, which is a hardware component) of the distribution server 20. The control section 23 includes an obtaining circuit 230, a processing circuit 231, and a distribution circuit 232.

The obtaining circuit 230 obtains a sound signal obtained from a microphone (hereinafter occasionally referred to as microphone). The microphone is used in a live venue, obtains a sound (for example, performance sound) generated in the live venue, and outputs a sound signal based on the obtained sound. The performance sound is, for example, a sound of one or various musical instruments (including a vocalist's singing voice) used in a performance. The sound signal output from the microphone is transmitted to the distribution server 20 via a communication device and/or another device. The microphone may have at least one of the following functions: a sound sensor that obtains a performance sound output from a musical instrument; an input device that receives a sound signal output from an electronic musical instrument; and a microphone that obtains a performer's singing/vocal sound. For example, in a case where a performer plays a musical instrument while singing, it is possible to use a plurality of microphones including a microphone that obtains a sound of the musical instrument. In a case where a performer plays a single musical instrument, a single sound signal includes a performance sound of the single musical instrument. In a case where a performer plays a plurality of musical instruments and a single microphone is used for sound collection, a single sound signal includes sounds of the plurality of musical instruments.

In the live venue, a camera is provided. The camera takes an image of the performer(s) and outputs image data of the image. An example of the image data is movie data. The image data is transmitted to the distribution server 20 via a communication device and/or another device. The obtaining circuit 230 of the distribution server 20 is capable of obtaining this image data.

The obtaining circuit 230 outputs the sound signal to the processing circuit 231.

The processing circuit 231 obtains the sound signal from the obtaining circuit 230, and performs various kinds of processing on the obtained sound signal. Examples of the processing include processing of assigning meta-data to the sound signal, and synthesis processing. The synthesis processing is processing of generating a single sound signal by synthesizing a plurality of sound signals.

Meta-data will be described. Meta-data is information indicating a sound signal type. The sound signal type is the type of a sound collected in a performance. The sound signal type may be represented in any form of indication insofar as the type of a sound recognizable. Examples include the type of a sound itself, such as a vocal sound, a guitar sound, a base sound, and an audience-emitted sound; and a sound signal role. An exemplary sound signal role is an indication as to which sound signal is a main sound or a secondary sound, in a case where there are a plurality of sound signals.

The main sound is a sound specified as a sound to serve as a main sound in a performance sound. For example, in a case where a vocal-type sound signal is specified as a main sound, the vocal-type sound signal is used as the main sound. In a case where a guitar-type sound signal is specified as a main sound, the guitar-type sound signal is used as the main sound.

The secondary sound is a sound specified as a sound to serve as a secondary sound in a performance sound. The secondary sound is set to a sound signal different from the sound signal of the sound specified as the main sound. It is possible to accept an instruction to set a sound signal to the secondary sound, or it is possible to set, to the secondary sound, a sound signal that has not been specified as the main sound.

In a case where the processing circuit 231 assigns meta-data to a sound signal, the processing circuit 231 refers to information indicating what type of sound was collected by the microphone that has collected the sound signal. Then, the processing circuit 231 assigns the type to the sound signal as meta-data. For example, in a case where a predetermined microphone collects the sound of a predetermined musical instrument, a person such as an administrator specifies a correlation between the type of the musical instrument and the microphone. Based on the specified correlation, the processing circuit 231 identifies the type of the sound signal output from the microphone, and assigns the identified type to the sound signal as its meta-data. The processing circuit 231 correlates the sound signal with its assigned meta-data, and causes the storage section 22 to store, as the meta-data 220, the sound signal and its assigned meta-data.

Also in a case where the processing circuit 231 assigns meta-data to a sound signal, data based on meta-data specifying information may be assigned as meta-data by a person such as an administrator. The meta-data specifying information specifies a sound signal role.

For example, an administrator operates a terminal device (such as a smartphone) to input meta-data specifying information. The meta-data specifying information is information specifying whether a sound signal included in a performance sound is a main sound or a secondary sound. The terminal device transmits the input meta-data specifying information to the distribution server 20.

The processing circuit 231 obtains the meta-data specifying information via the obtaining circuit 230. Based on the obtained information, the processing circuit 231 causes the storage section 22 to include correlation information in the meta-data 220. The correlation information indicates a correlation between a sound signal of the performance sound to be distributed with a main sound and a correlation between another sound signal of the performance sound to be distributed with a secondary sound.

The processing circuit 231 outputs the generated sound signals to the distribution circuit 232.

The distribution circuit 232 distributes each sound signal and its meta-data to the viewer terminal 10. In a case where there is a moving image taken by the camera, the distribution circuit 232 also distributes image data of the moving image.

Next, the viewer terminal 10 of the viewer system 100 will be described. The viewer terminal 10 includes a communication section 11, a storage section 12, a control section 13, and a display section 14.

The communication section 11 communicates with the distribution server 20. The storage section 12 is implemented by a storage medium such as an HDD (Hard Disk Drive), a flash memory, an EEPROM (Electrically Erasable Programmable Read Only Memory), a RAM (Random Access read/write Memory), a ROM (Read Only Memory), or a combination of the foregoing. The storage section 12 stores a program for performing various kinds of processing in the viewer terminal 10, and stores temporary data used in the various kinds of processing.

The storage section 12 stores, for example, the sound environment data 120 and the registration data 121. The sound environment data 120 is information indicating a sound characteristic of a sound appliance (audio appliance) provided at a viewing place. As used herein, the term “sound characteristic” is intended to mean a quality of a sound that is output from a sound appliance provided at a viewing place and that can be perceived at the viewing place. For example, in a case where the sound appliance is a speaker, the sound characteristic is a quality of a sound output from the speaker, examples including reproduction frequency band, directivity angle, and rated output. The sound environment data 120 may not necessarily indicate a sound characteristic itself but may be information from which a sound characteristic can be identified. For example, the sound environment data 120 may be a sound appliance's identification information such as type name and serial number. In this case, based on a sound appliance's identification information indicated by the sound environment data 120, the viewer terminal 10 may obtain a sound characteristic of the sound appliance from, for example, an external server. The sound environment data 120 of a viewer's sound appliance is registered in advance by the viewer's registration operation on the viewer terminal 10.

In registering the viewer's own sound appliance, the viewer may also register information indicating location of the sound appliance. In this case, the sound environment data 120 includes information indicating what sound appliance is located at what position in the viewing place.

The registration data 121 is information indicating a sound preferred by a viewer. For example, the viewer operates the viewer terminal 10 to input information indicating a sound signal preferred by the viewer. The viewer terminal 10 obtains the input information and causes the storage section 12 to store the obtained information as the registration data 121. The control section 13 controls the communication section 11, the storage section 12, and the display section 14. The control section 13 includes an obtaining circuit 130 and a device control circuit 132.

The obtaining circuit 130 obtains various kinds of information. For example, the obtaining circuit 130 obtains a distributed sound signal and its meta-data via the communication section 11. The obtaining circuit 130 outputs the obtained sound signal and meta-data to the device control circuit 132. The obtaining circuit 130 also obtains an operation content from the viewer via an input device such as a touch panel provided on the viewer terminal 10.

The device control circuit 132 receives a first sound signal, a second sound signal, and meta-data from the distribution server 20, and receives the sound environment data 120. Then, based on a combination of the type and the sound characteristic, the device control circuit 132 outputs the first sound signal or the second sound signal to a first speaker provided at the viewing place.

### Case 1

The device control circuit 132 refers to the sound environment data 120 to obtain a sound characteristic of the speaker provided at the viewing place. From the sound characteristic, the device control circuit 132 identifies the sound range of the sound output from the speaker.

Also, based on the sound type indicated by the meta-data of the sound signal, the device control circuit 132 identifies the sound range of the sound included in the sound signal. The device control circuit 132 identifies the sound range of the sound included in the sound signal based on, for example, a correlation between a musical instrument and the sound range of the sound output from the musical instrument. Data indicating this correlation may be stored in, for example, the storage section 12 as correlation data, or may be stored in the storage section 22 of the distribution server 20. The device control circuit 132 is able to identify the sound range of the sound included in the sound signal using the correlation data stored in the storage section 12 or the storage section 22.

The device control circuit 132 identifies a speaker capable of outputting a sound having a sound range equivalent to or wider than the sound range of the sound included in the sound signal.

### Case 2

The device control circuit 132 refers to the sound environment data 120 to obtain the number of speakers provided at the viewing place. In a case where a plurality of speakers are provided at the viewing place, the device control circuit 132 identifies the speaker to which to output the sound signal based on a sound characteristic of each speaker.

For example, it will be assumed that two speakers (a first speaker and a second speaker) are provided at the viewing place. The first speaker is a device capable of outputting a sound having a comparatively wide sound range. An example of the first speaker is a loudspeaker. The second speaker is a device capable of outputting a sound having a comparatively narrow sound range. An example of the second speaker is a speaker incorporated in a smartphone. In this case, the device control circuit 132 uses the sound environment data 120 to determine the first speaker as a speaker capable of outputting a sound having a wider sound range. Then, the device control circuit 132 identifies the first speaker as a speaker to output a main sound. The device control circuit 132 uses the sound environment data 120 to determine the second speaker as a speaker that outputs a sound having a sound range narrower than the sound range of the sound from the first speaker. Then, the device control circuit 132 identifies the second speaker as a speaker to output a secondary sound. In this manner, the device control circuit 132 causes the first speaker to output the main sound, and causes the second speaker to output the secondary sound.

### Case 3

The device control circuit 132 refers to the registration data 121 to obtain the type of the sound specified by the viewer. Based on the type of the sound specified by the viewer, the device control circuit 132 identifies the speaker to which to output the sound signal.

For example, it will be assumed that two speakers (a first speaker and a second speaker) are provided at the viewing place, similarly to the above-described case. The device control circuit 132 uses the sound environment data 120 to determine the first speaker as a speaker capable of outputting a sound having a wider sound range. Then, the device control circuit 132 identifies the first speaker as a speaker to output the sound specified by the viewer. The device control circuit 132 uses the sound environment data 120 to determine the second speaker as a speaker that outputs a sound having a sound range narrower than the sound range of the sound from the first speaker. Then, the device control circuit 132 identifies the second speaker as a speaker to output sound other than the sound specified by the viewer.

### Another Case

The device control circuit 132 may identify a speaker to output a sound signal based on location of the speaker provided at the viewing place. The location of the speaker is determined based on, for example, the sound environment data 120. For example, in a case where the speaker is incorporated in a smartphone, the speaker is assumed to be comparatively near the viewer. In a case where the speaker is installed in a room, the speaker is assumed to be away from the viewer.

Generally, as the distance from the viewer to the speaker is shorter, it is less necessary to consider the influence of the space through which sound propagates, and the sound output from the speaker is believed to propagate to the viewer's ears without no or minimal degradation. In view of this knowledge, the device control circuit 132 may identify a speaker located close to the viewer as a speaker to output a main sound or the sound specified by the viewer.

It is to be noted that the volume of the sound output from each speaker provided at the viewing place may be determined based on location of the each speaker. For example, the device control circuit 132 causes a speaker located close to the viewer to output a sound having a comparatively small level of volume. In contrast, the device control circuit 132 causes a speaker located away from the viewer to output a sound having a comparatively high level of volume.

The display section 14 includes a display device such as a liquid crystal display, and is controlled by the control section 13 to display an image, such as a movie, associated with a live performance.

The speakers 15 to 17 each output a sound that is based on a sound signal output from the viewer terminal 10. The speakers 15 to 17 are connectable to the viewer terminal 10. For example, each of the speakers 15 to 17 is a loudspeaker provided in a viewing space or a speaker incorporated in the viewer terminal 10.

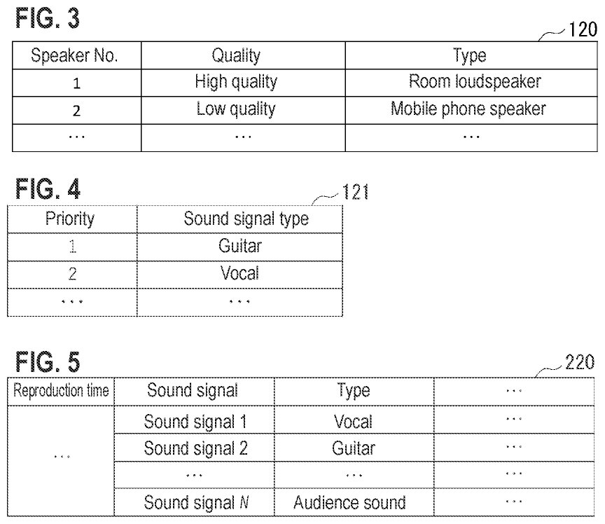

The sound environment data 120 will be described by referring to FIG. 3. FIG. 3 illustrates an example of the sound environment data 120 according to the one embodiment. As illustrated in FIG. 3, the sound environment data 120 has items Speaker No., Quality, and Type, and stores information corresponding to each item. Speaker No. is identification information by which a speaker is uniquely identified. An example of Speaker No. is number. Quality is information indicating quality of the speaker identified by Speaker No. Type is information indicating type of a speaker.

In the example illustrated in FIG. 3, two speakers are provided at the viewing place of the viewer; a high quality loudspeaker and a speaker incorporated in a low quality smartphone.

The registration data 121 will be described by referring to FIG. 4. FIG. 4 illustrates an example of the registration data 121 according to the one embodiment. As illustrated in FIG. 4, the registration data 121 has items Priority and Sound signal type, and stores information corresponding to each item. Priority indicates priority of the type of sound preferred by the viewer. In the example illustrated in FIG. 4, guitar and vocal are prioritized in this order as priority of the type of sound preferred by the viewer.

The meta-data 220 will be described by referring to FIG. 5. FIG. 5 illustrates an example of the meta-data 220 according to the one embodiment. As illustrated in FIG. 5, the meta-data 220 has items Reproduction time, Sound signal, and Type, and stores data corresponding to each item. Reproduction time is information indicating a passing time relative to the time of start in a performance sound related to a live performance. Sound signal is identification information identifying a sound signal reproduced at the reproduction time. For example, Sound signal identifies each of a plurality of sound signals. Type is information indicating type of a sound signal.

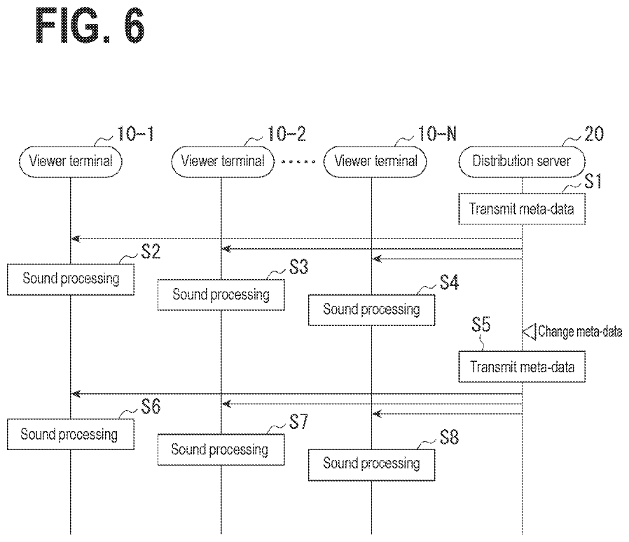

FIG. 6 is a sequence chart for describing a flow of processing performed by the distribution system 1 according to the one embodiment. The following example assumes that a plurality of viewers are using their viewer terminals 10 to view a live performance by viewing or listening to moving images related to the live performance and/or sound signals distributed from the distribution server 20. The following example also assumes that meta-data is distributed intermittently.

The distribution server 20 distributes meta-data to each viewer terminal 10 (the viewer terminals 10-1 to 10-N) (step S1). Each viewer terminal 10 receives the meta-data and performs sound processing based on the received meta-data (steps S2 to S4). A flow of this sound processing will be described in detail later. When the meta-data is changed, the distribution server 20 distributes the changed meta-data to each viewer terminal 10 (step S5). Each viewer terminal 10 receives the changed meta-data and performs sound processing based on the changed meta-data (steps S6 to S8).

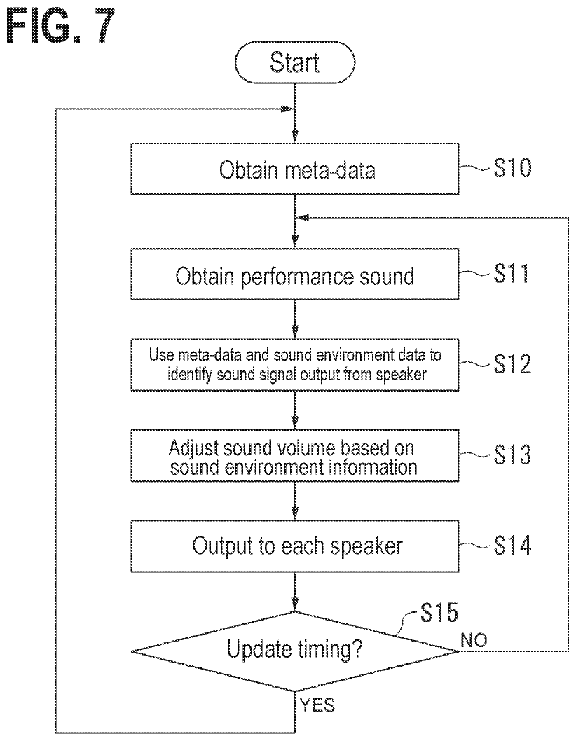

FIG. 7 is a flowchart of the above-described sound processing. The viewer terminal 10 obtains meta-data (step S10). The viewer terminal 10 obtains a sound signal (step S11). The viewer terminal 10 uses the sound signal, the meta-data, and the sound environment data 120 to identify a sound signal to be output from the speaker (step S12). The viewer terminal 10 uses the sound environment data 120 to adjust the sound volume, as necessary (step S13). The viewer terminal 10 outputs the volume-adjusted sound signal to the speaker (step S14). In this manner, a sound that is based on the sound signal is output from the speaker.

The viewer terminal 10 determines whether an update timing for meta-data has come (step S15). For example, in a case where a silence has continued for a predetermined period of time in the distributed sound signal, the viewer terminal 10 determines that an update timing has come. Upon determining that an update timing has come, the viewer terminal 10 returns to the processing at step S10 to change the meta-data to latest meta-data. Upon determining that an update timing has not come, the viewer terminal 10 returns to the processing at step S11.

As has been described hereinbefore, the distribution system 1 according to the one embodiment is a system that distributes information for the distribution server 20 to cause a performance sound to be output. The distribution system 1 includes the device control circuit 132. The device control circuit 132 receives a plurality of sound signals (the first sound signal and the second sound signal) related to a performance sound, and meta-data indicating the type of each of the plurality of sound signals in a performance sound. Based on a combination of the type and a sound characteristic of a sound appliance, the device control circuit 132 causes any one of the plurality of sound signals to be output from the speaker (first speaker) provided at the viewing place.

With this configuration, the distribution system 1 according to the one embodiment is capable of outputting a sound suitable for the speaker provided at the viewing place. Specifically, there may be a case where speakers having different sound characteristics are provided at different viewing places. In this case, the distribution system 1 is capable of outputting a sound suitable for each of these speakers.

Also in the distribution system 1 according to the one embodiment, the meta-data may include information indicating a main sound and a secondary sound in a performance sound. The sound environment data 120 may include information indicating a sound range of the speaker provided at the viewing place. In a case where two sound output devices are provided at a viewing place, the device control circuit 132 refers to the meta-data to cause the higher quality speaker (for example, the first speaker in a case where the first speaker is wider in sound range than the second speaker) to output a sound signal to which meta-data indicating the main sound is assigned and cause the lower quality speaker (for example, the second speaker) to output a sound signal to which meta-data indicating the secondary sound is assigned. With this configuration, when the distribution system 1 according to the one embodiment identifies a speaker to output a sound specified as a main sound or a secondary sound, the identified speaker conveys the intended purpose behind specifying the sound as a main sound or a secondary sound.

Also in the distribution system 1 according to the one embodiment, the meta-data may include information indicating a viewer-registered priority corresponding to the type of the sound signal. The device control circuit 132 causes the first speaker to output the first sound signal or the second sound signal based on the priority specified by the meta-data. With this configuration, the distribution system 1 according to the one embodiment is capable of outputting a sound that conveys the preference registered by a viewer.

Also in the distribution system 1 according to the one embodiment, the meta-data may be update in a case where a silence has continued for a predetermined period of time. With this configuration, in the distribution system 1 according to the one embodiment, the frequency of meta-data update is lower than when the meta-data is updated continually. As a result, the distribution system 1 handles a reduced processing workload. Additionally, the meta-data is changed to latest meta-data at a point of time when it is highly possible that the meta-data is changed. This enables the distribution system 1 to generate a sound output that aligns with the current state of the performance sound.

The above-described one embodiment is an example in which the viewer terminal 10 identifies a sound to be output from the speaker provided at a viewing place. This example, however, is not intended in a limiting sense. It may be the distribution server 20 that identify a sound signal to be output from the speaker provided at each viewing place based on each viewer's sound environment data.

In this case, the storage section 22 of the distribution server 20 stores sound environment data 120 and registration data 121 for each viewer. Also in the above case, the distribution server 20 includes a function corresponding to the device control circuit 132. The distribution server 20 identifies a sound signal to be output from the speaker provided at each viewing place based on the sound environment data 120 and the registration data 121 of the viewer at the each viewing place. The distribution server 20 distributes the identified sound signal to the viewer terminal 10. For example, the sound signal distributed to the viewer terminal 10 is linked with meta-data indicating a control signal that indicates the speaker from which the sound signal is to be output.

Also, the sound to be output from the speaker may be a sound obtained by performing sound source separation from a sound signal. For example, there may be a case where a distributed single sound signal includes sounds of a plurality of types of musical instruments. In this case, it is possible to perform sound source separation on the sound signal for each musical instrument type to generate a sound signal for each musical instrument type and cause the speaker to output the generated sound signal.

The above-described one embodiment is an example in which a sound related to a live performance is output from the speaker. This configuration, however, is not intended in a limiting sense. The distribution system 1 according to the one embodiment is also applicable to outputting of a performance sound different from a live performance. Also, distribution system 1 according to the one embodiment will not be limited to outputting of a performance sound distributed in real-time but is also applicable to outputting of a performance sound on-demand.

A program for implementing the functions of the processors (the control section 13 and the control section 23) illustrated in FIG. 1 may be stored in a computer readable recording medium. The program recorded in the recording medium may be read into a computer system and executed therein. An operation management may be performed in this manner. As used herein, the term “computer system” is intended to encompass hardware such as OS (Operating System) and peripheral equipment.

Also as used herein, the term “computer system” is intended to encompass home-page providing environments (or home-page display environments) insofar as the WWW (World Wide Web) is used. Also, Also as used herein, the term “computer readable recording medium” is intended to mean: a transportable medium such as a flexible disk, a magneto-optical disk, a ROM (Read Only Memory), a CD-ROM (Compact Disk Read Only Memory); and a storage device such as a hard disk incorporated in a computer system. Also as used herein, the term “computer readable recording medium” is intended to encompass a recording medium that holds a program for a predetermined time period. An example of such recording medium is a volatile memory inside a server computer system or a client computer system. It will also be understood that the program may implement only some of the above-described functions, or may be combinable with a program(s) recorded in the computer system to implement the above-described functions. It will also be understood that the program may be stored in a predetermined server, and that in response to a demand from another device or apparatus, the program may be distributed (such as by downloading) via a communication line.

While embodiments of the present disclosure have been described in detail by referring to the accompanying drawings, the embodiments described above are not intended as limiting specific configurations of the present disclosure, and various other designs are possible without departing from the scope of the present disclosure.

What is claimed is:

1. A distribution system comprising:
a device control circuit configured to:
receive a first sound signal and a second sound signal that are related to a performance sound to be distributed;
receive meta-data indicating a type of the first sound signal and a type of the second sound signal;
receive sound environment data indicating a sound characteristic of a sound appliance; and
based on a combination of the type of the first sound signal and the sound characteristic or a combination of the type of the second sound signal and the sound characteristic, control the first sound signal or the second sound signal to be output to the sound appliance.

2. The distribution system according to claim 1,
wherein the meta-data comprises
first meta-data assigned to the first sound signal and indicating whether the first sound signal is a main sound or a secondary sound in the performance sound, and
second meta-data assigned to the second sound signal and indicating whether the second sound signal is the main sound or the secondary sound in the performance sound,
wherein the sound appliance comprises a first speaker and a second speaker that are provided at a viewing place to which the performance sound is to be distributed,
wherein the sound environment data comprises
information indicating a sound range of the first speaker,
information indicating a sound range of the second speaker, and
wherein the device control circuit is further configured to refer to the meta-data to:
cause one of the first speaker and the second speaker that is wider in the sound range to output the first sound signal when the first meta-data indicates that the first sound signal is the main sound; and
cause the other of the first speaker and the second speaker to output the second sound signal when the second meta-data indicates that the second sound signal is the secondary sound.

3. The distribution system according to claim 1,
wherein the meta-data comprises information indicating a viewer-registered priority of the type of the first sound signal and the type of the second sound signal,
wherein the sound appliance comprises a first speaker provided at a viewing place to which the performance sound is to be distributed, and
wherein the device control circuit is further configured to cause the first speaker to output the first sound signal or the second sound signal based on the viewer-registered priority.

4. The distribution system according to claim 1,
wherein the meta-data is changed upon change in at least one of the type of the first sound signal or the type of the second sound signal based on progress of a performance of the performance sound,
wherein the sound appliance comprises a first speaker provided at a viewing place to which the performance sound is to be distributed, and
wherein in a case where a silence has continued for equal to or longer than a predetermined time period in the performance sound, the device control circuit is further configured to:
update the meta-data to a latest version as of passing of the predetermined time period the silence; and
use the latest version of the meta-data to cause the first sound signal or the second sound signal to be output from the first speaker based on the combination of the type of the first sound signal and the sound characteristic or the combination of the type of the second sound signal and the sound characteristic.

5. The distribution system according to claim 2,
wherein the meta-data is changed upon change in at least one of the type of the first sound signal or the type of the second sound signal based on progress of a performance of the performance sound, and
wherein in a case where a silence has continued for equal to or longer than a predetermined time period in the performance sound, the device control circuit is further configured to:
update the meta-data to a latest version as of passing of the predetermined time period the silence; and
use the latest version of the meta-data to cause the first sound signal or the second sound signal to be output from the first speaker based on the combination of the type of the first sound signal and the sound characteristic or the combination of the type of the second sound signal and the sound characteristic.

6. The distribution system according to claim 3,
wherein the meta-data is changed upon change in at least one of the type of the first sound signal or the type of the second sound signal based on progress of a performance of the performance sound, and
wherein in a case where a silence has continued for equal to or longer than a predetermined time period in the performance sound, the device control circuit is further configured to:
update the meta-data to a latest version as of passing of the predetermined time period the silence; and
use the latest version of the meta-data to cause the first sound signal or the second sound signal to be output from the first speaker based on the combination of the type of the first sound signal and the sound characteristic or the combination of the type of the second sound signal and the sound characteristic.

7. A sound outputting method performed by a computer used in a distribution system, the sound outputting method comprising:
receiving a first sound signal and a second sound signal that are related to a performance sound to be distributed;
receiving meta-data indicating a type of the first sound signal and a type of the second sound signal;
receiving sound environment data indicating a sound characteristic of a sound appliance; and
based on a combination of the type of the first sound signal and the sound characteristic or a combination of the type of the second sound signal and the sound characteristic, controlling the first sound signal or the second sound signal to be output to the sound appliance.

8. The sound outputting method according to claim 7,
wherein the meta-data comprises
first meta-data assigned to the first sound signal and indicating whether the first sound signal is a main sound or a secondary sound in the performance sound, and
second meta-data assigned to the second sound signal and indicating whether the second sound signal is the main sound or the secondary sound in the performance sound,
wherein the sound appliance comprises a first speaker and a second speaker that are provided at a viewing place to which the performance sound is to be distributed,
wherein the sound environment data comprises
information indicating a sound range of the first speaker,
information indicating a sound range of the second speaker, and
wherein the meta-data is referred to:
cause one of the first speaker and the second speaker that is wider in the sound range to output the first sound signal when the first meta-data indicates that the first sound signal is the main sound; and
cause the other of the first speaker and the second speaker to output the second sound signal when the second meta-data indicates that the second sound signal is the secondary sound.

9. The sound outputting method according to claim 7,
wherein the meta-data comprises information indicating a viewer-registered priority of the type of the first sound signal and the type of the second sound signal,
wherein the sound appliance comprises a first speaker provided at a viewing place to which the performance sound is to be distributed, and
wherein the first speaker is caused to output the first sound signal or the second sound signal based on the viewer-registered priority.

10. The sound outputting method according to claim 7,
wherein the meta-data is changed upon change in at least one of the type of the first sound signal or the type of the second sound signal based on progress of a performance of the performance sound,
wherein the sound appliance comprises a first speaker provided at a viewing place to which the performance sound is to be distributed, and
wherein in a case where a silence has continued for equal to or longer than a predetermined time period in the performance sound,
the meta-data is updated to a latest version as of passing of the predetermined time period the silence; and
the latest version of the meta-data is used to cause the first sound signal or the second sound signal to be output from the first speaker based on the combination of the type of the first sound signal and the sound characteristic or the combination of the type of the second sound signal and the sound characteristic.

11. The sound outputting method according to claim 8,
wherein the meta-data is changed upon change in at least one of the type of the first sound signal or the type of the second sound signal based on progress of a performance of the performance sound, and
wherein in a case where a silence has continued for equal to or longer than a predetermined time period in the performance sound,
the meta-data is updated to a latest version as of passing of the predetermined time period the silence; and
the latest version of the meta-data is used to cause the first sound signal or the second sound signal to be output from the first speaker based on the combination of the type of the first sound signal and the sound characteristic or the combination of the type of the second sound signal and the sound characteristic.

12. The sound outputting method according to claim 9,
wherein the meta-data is changed upon change in at least one of the type of the first sound signal or the type of the second sound signal based on progress of a performance of the performance sound, and
wherein in a case where a silence has continued for equal to or longer than a predetermined time period in the performance sound,
the meta-data is updated to a latest version as of passing of the predetermined time period the silence; and
the latest version of the meta-data is used to cause the first sound signal or the second sound signal to be output from the first speaker based on the combination of the type of the first sound signal and the sound characteristic or the combination of the type of the second sound signal and the sound characteristic.

13. A non-transitory computer-readable recording medium storing a program that, when executed by at least one computer used in a distribution system, cause the at least one computer to perform a method comprising:
receiving a first sound signal and a second sound signal that are related to a performance sound to be distributed;
receiving meta-data indicating a type of the first sound signal and a type of the second sound signal;
receiving sound environment data indicating a sound characteristic of a sound appliance; and
based on a combination of the type of the first sound signal and the sound characteristic or a combination of the type of the second sound signal and the sound characteristic, controlling the first sound signal or the second sound signal to be output to the sound appliance.

14. The non-transitory computer-readable recording medium according to claim 13,
wherein the meta-data comprises
first meta-data assigned to the first sound signal and indicating whether the first sound signal is a main sound or a secondary sound in the performance sound, and
second meta-data assigned to the second sound signal and indicating whether the second sound signal is the main sound or the secondary sound in the performance sound,
wherein the sound appliance comprises a first speaker and a second speaker that are provided at a viewing place to which the performance sound is to be distributed,
wherein the sound environment data comprises
information indicating a sound range of the first speaker,
information indicating a sound range of the second speaker, and
wherein the meta-data is referred to:
cause one of the first speaker and the second speaker that is wider in the sound range to output the first sound signal when the first meta-data indicates that the first sound signal is the main sound; and
cause the other of the first speaker and the second speaker to output the second sound signal when the second meta-data indicates that the second sound signal is the secondary sound.

15. The non-transitory computer-readable recording medium according to claim 13,
wherein the meta-data comprises information indicating a viewer-registered priority of the type of the first sound signal and the type of the second sound signal,
wherein the sound appliance comprises a first speaker provided at a viewing place to which the performance sound is to be distributed, and
wherein the first speaker is caused to output the first sound signal or the second sound signal based on the viewer-registered priority.

16. The non-transitory computer-readable recording medium according to claim 13,
wherein the meta-data is changed upon change in at least one of the type of the first sound signal or the type of the second sound signal based on progress of a performance of the performance sound,
wherein the sound appliance comprises a first speaker provided at a viewing place to which the performance sound is to be distributed, and
wherein in a case where a silence has continued for equal to or longer than a predetermined time period in the performance sound,
the meta-data is updated to a latest version as of passing of the predetermined time period the silence; and
the latest version of the meta-data is used to cause the first sound signal or the second sound signal to be output from the first speaker based on the combination of the type of the first sound signal and the sound characteristic or the combination of the type of the second sound signal and the sound characteristic.

17. The non-transitory computer-readable recording medium according to claim 14,
wherein the meta-data is changed upon change in at least one of the type of the first sound signal or the type of the second sound signal based on progress of a performance of the performance sound, and
wherein in a case where a silence has continued for equal to or longer than a predetermined time period in the performance sound,
the meta-data is updated to a latest version as of passing of the predetermined time period the silence; and
the latest version of the meta-data is used to cause the first sound signal or the second sound signal to be output from the first speaker based on the combination of the type of the first sound signal and the sound characteristic or the combination of the type of the second sound signal and the sound characteristic.

18. The non-transitory computer-readable recording medium according to claim 15,
wherein the meta-data is changed upon change in at least one of the type of the first sound signal or the type of the second sound signal based on progress of a performance of the performance sound, and
wherein in a case where a silence has continued for equal to or longer than a predetermined time period in the performance sound,
the meta-data is updated to a latest version as of passing of the predetermined time period the silence; and
the latest version of the meta-data is used to cause the first sound signal or the second sound signal to be output from the first speaker based on the combination of the type of the first sound signal and the sound characteristic or the combination of the type of the second sound signal and the sound characteristic.
